(19) United States
(12) Patent Application Publication
(10) Pub. No.: US 2016/0179023 A1
(43) Pub. Date: Jun. 23, 2016

(54) FILM-FORMING TONER

(71) Applicant: CASIO COMPUTER CO., LTD., Tokyo (JP)

(72) Inventors: Hideyoshi NIINUMA, Hanno-shi (JP); Toshiaki KANAMURA, Ome-shi (JP)

(73) Assignee: CASIO COMPUTER CO., LTD., Shibuya-ku, Tokyo (JP)

(21) Appl. No.: 15/055,470

(22) Filed: Feb. 26, 2016

Related U.S. Application Data
(63) Continuation of application No. PCT/JP2014/071212, filed on Aug. 11, 2014.

(30) Foreign Application Priority Data
Sep. 24, 2013 (JP) 2013-197006

(51) Int. Cl. G03G 9/08

(52) U.S. Cl. CPC G03G 9/0819

(57) ABSTRACT

Provided is a film-forming toner excellent in grindability hand having a sufficient negative chargeability, and facilitate grinding performed in the manufacture. The film-forming toner contains a main resin, and a low-molecular-weight resin having a weight-average molecular weight lower than that of the main resin. The low-molecular-weight resin is one or more resins selected from terpene resins, alicyclic hydrocarbon resins, α-methylpolystyrene, modified rosin, novolak resins, modified novolak resins, aliphatic hydrocarbon resins, aromatic hydrocarbon resins, copolymerized resins of these resins, esterified modified rosin, a coumarone resin, C5 and C9 petroleum resins, and derivatives thereof. A proportion of the low-molecular-weight resin in the film-forming toner is 5 to 40 mass %. The film-forming toner has an average particle diameter D50 (volume) of 9 to 50 μm.

### CROSS-REFERENCE TO RELATED APPLICATIONS

This is a Continuation Application of PCT Application No. PCT/JP2014/071212, filed Aug. 11, 2014 and based upon and claims the benefit of priority from the Japanese Patent Application number 2013-197006, filed on. Sep. 24, 2013, the entire contents of all of which are incorporated herein by reference.

### BACKGROUND OF THE INVENTION

1. Field of the Invention

The present invention relates to film-forming toner.

2. Description of the Related Art

A label is generally manufactured by the following method. First, prepared is a label sheet in which a self-adhesive layer is provided on one surface and covered with a release paper. Then, a pattern is printed on this label sheet. After that, the label sheet is cut into an arbitrary shape.

Unfortunately, this method has the problem that the cost of the manufacturing apparatus is high because the method requires a plate for printing the pattern, and a cutter such as a punching die for cutting the label sheet.

Accordingly, a method of manufacturing a label is proposed in which toner is developed into an arbitrary shape by an electrophotographic method and then thermally fixed (see patent literature 1). However, polyester resins or styrene acrylic resins widely used as toner resins are sufficiently hard but brittle. Thus, these resins have inferior film characteristics and cannot be used for a label base.

In the electrophotographic method, negatively chargeable toner is generally used. However, some resins capable of achieving performance required of a film are positively chargeable or weakly negatively chargeable. In addition, when increasing the particle size of film-forming toner, the negative chargeability further decreases.

Also, a resin having superior film characteristics has a low glass transition temperature and hence is lacking grindability at room temperature.

Note that methods of mixing a resin with another resin are known, but these methods have been described as means for solving mechanical problems such as a strength and shock resistance (e.g., patent literatures 2 and 3). No film-forming electrophotographic toner aiming at improving the chargeability and grindability has been disclosed.

### CITATION LIST

### Patent Literatures

Patent Literature 1: Jpn. Pat. Appln. KOKAI Publication No. 2007-283745
Patent Literature 2: Jpn. Pat. Appln. KOKAI Publication No. 2009-108292
Patent Literature 3: Jpn. Pat. Appln. KOKAI Publication No. 2009-108276

### BRIEF SUMMARY OF THE INVENTION

The present invention has been made in consideration of the above situation, and has as its object to make it possible to manufacture film-forming toner having a sufficient negative chargeability, and facilitate grinding performed in the manufacture.

According to an aspect of the present invention, there is provided film-forming toner comprising a main resin, and a low-molecular-weight resin having a weight-average molecular weight lower than that of the main resin, wherein the low-molecular-weight resin is one or more resins selected from the group consisting of terpene resins, alicyclic hydrocarbon resins, α-methylpolystyrene, modified rosin, novolak resins, modified novolak resins, aliphatic hydrocarbon resins, aromatic hydrocarbon resins, copolymerized resins of these resins, esterified modified rosin, a coumarone resin, C5 and C9 petroleum resins, and derivatives thereof, a proportion of the low-molecular-weight resin in the film-forming toner is 5 to 40 mass %, and the film-forming toner has an average particle diameter D50 (volume) of 9 to 50 μm.

The present invention makes it possible to manufacture film-forming toner having a sufficient negative chargeability, and facilitate grinding performed in the manufacture.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing an example of a printer to be used to print film-forming toner of an embodiment; and

FIG. 2 is a view showing an image sample printed by using the film-forming toner.

### DETAILED DESCRIPTION OF THE INVENTION

Film-forming toner according to an embodiment of the present invention will be explained below.

This film-forming toner contains a main resin as a binder resin, a low-molecular-weight resin having a weight-average molecular weight lower than that of the main resin, and an arbitrary internal additive and/or arbitrary external additive as additives. The film-forming toner may further contain a colorant.

The main resin has superior film characteristics. In this specification, the film characteristics mean properties by which a film is readily formable by methods such as melt extrusion molding, calendaring, and stretching, the brittle temperature falls within a negative range, and elasticity is obtained at room temperatures.

The main resin can have either positive chargeability or negative chargeability. The chargeability relationship between the main resin and the low-molecular-weight resin will be described later.

The weight-average molecular weight of the main resin is, e.g., about 10,000 to about 250,000, and preferably, about 20,000 to about 200,000.

The softening point of the main resin is, e.g., about 90° C. to about 160° C.

As the main resin, it is possible to use, e.g., one or more resins selected from the group consisting of polybutylene succinate (PBS) resins, polylactic acid resins, low-density polyethylene resins, straight-chain, low-density polyethylene resins, ethylene-vinyl acetate copolymer, ethylene-methacrylic acid copolymer, ionomer resins, acrylonitrile-butadiene-styrene copolymer, cyclic polyolefin copolymer, polyester sulfone resins, ethylene-ethylacrylate copolymer resin, polyethyleneterephthalate resins, polypropyrene resin, polystyrene resin, acetalized polyvinylalcohol resin, and derivatives thereof.

The low-molecular-weight resin is one or more resins selected from the group consisting of terpene resins, alicyclic hydrocarbon resins, α-methylpolystyrene, modified rosin, novolak resin, modified novolak resins, aliphatic hydrocarbon resins, aromatic hydrocarbon resins, copolymerized resins of these resins, esterified modified rosin, coumarone resin, C5 and C9 petroleum resins, and derivatives thereof.

Examples of the C5 petroleum resin are resins mainly containing isopropylene, piperine, 2-methylbutene, cyclopentadiene, etc. Examples of the C9 petroleum resin are resins mainly containing styrene, vinyltoluene, α-methylstyrene, indene, etc.

The weight-average molecular weight of the low-molecular-weight resin is, e.g., about 200 to about 10,000, and preferably, about 300 to about 5,000.

The low-molecular-weight resin has a softening point of about 50° C. to about 150° C., and is a solid at room temperatures.

The low-molecular-weight resin is inferior in film characteristics to the main resin, and hence is unsuitable as a binder resin of the film-forming toner. However, the low-molecular-weight resin has brittleness higher than that of the main resin. Therefore, when grinding a kneaded product containing these resins, the grindability improves due to this brittleness.

The low-molecular-weight resin typically has negative chargeability. When the main resin has negative chargeability, however, the low-molecular-weight resin need not have negative chargeability. Note that the low-molecular-weight resin is desirably a resin which does not hinder the negative chargeability of the main resin in this case as well. On the other hand, if the main resin has positive chargeability, the low-molecular-weight resin must have negative chargeability.

When using positively chargeable PBS as the main resin, it is preferable to use, as the low-molecular-weight resin, at least one negatively chargeable resin selected from hydrogenated terpene resins, aliphatic saturated hydrocarbon resins, and acid-modified colorless rosin.

The additive is not particularly restricted as long as it is generally used in electrophotographic toner. For example, it is possible to use internal additives such as a charge control agent, release agent, and grinding aid. An external additive may also be added as needed.

The ratio of the main resin contained in the film-forming toner with respect to the total mass (to be referred to as the toner mass hereinafter) of the abovementioned main resin, low-molecular-weight resin, and additives is, e.g., 50 mass % or more, and typically, 55 mass % or more.

The ratio of the low-molecular-weight resin contained in the film-forming toner with respect to the toner mass is preferably 5 to 40 mass %, and more preferably, 5 to 30 mass %.

If the ratio of the low-molecular-weight resin is excessively high, no elasticity required of the film-forming toner is obtained, and breaking or cracking readily occurs. If this ratio is excessively low, the grindability decreases, and the chargeability of the toner may become insufficient.

An average particle diameter D50 (volume) of the film-forming toner is typically 9 to 50 μm, and preferably, 20 to 30 μm. If the average particle diameter D50 is small, it is difficult to obtain a film having a sufficient thickness. If the average particle diameter D50 is large, the chargeability may become insufficient because the specific surface area reduces.

The film-forming toner explained above can be manufactured by, e.g., the following method. First, using the main resin as a binder resin, the low-molecular-weight resin and internal additive are added thereto, and they are mixed together. Then, the mixture is melt-kneaded by using a biaxial kneader or the like. After that, the kneaded product is cooled and ground by using a mill or the like, thereby obtaining a ground product. Film-forming toner is manufactured by adding an external additive to this ground product.

An example of a printer that is used for printing the film-forming toner explained above on a self-adhesive sheet for forming a film will be explained with reference to the accompanying drawings.

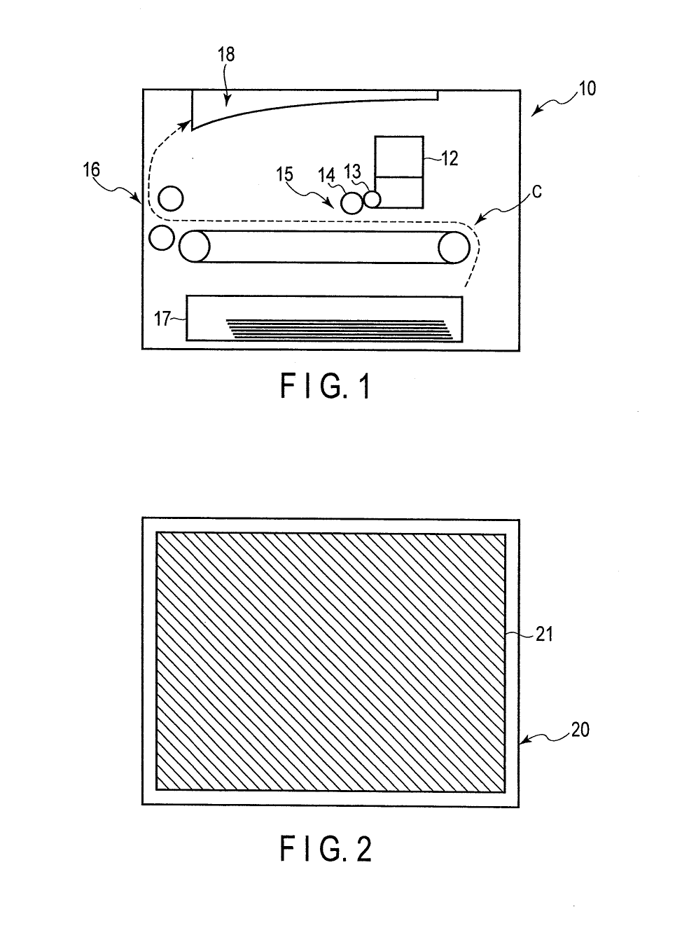

The printer 10 shown in FIG. 1 is obtained by modifying a commercially available “N6000” manufactured by CASIO CO., LTD. In the printer 10, a TS 12, developing roll 13, photosensitive body 14, transfer unit 15, and fixing unit 16 are arranged around a printing belt 11. A cassette 17 for accommodating self-adhesive sheets on each of which a film is to be formed is provided at the bottom portion of the printer, and a sheet discharge unit 18 for discharging a printed sheet is provided at the upper portion thereof. The film-forming toner is contained in the TS 12.

The printer 10 shown in FIG. 1 operates as follows.

First, a self-adhesive sheet on which a film is to be formed is supplied from the cassette 17, and passed through each unit along a sheet path C. A toner image developed on the photosensitive body 14 is transferred onto the sheet having arrived at the transfer unit 15. The developed image is an image obtained by developing the film-forming toner supplied from the TS 12 on the photosensitive body 14 by the developing roll 13.

The sheet carrying the image (toner) transferred by the transfer unit 15 is conveyed to the fixing unit along the sheet path C and undergoes a fixing process, thereby fixing the film-forming toner. After that, the sheet is discharged to the sheet discharge unit 18, and the operation is complete.

### EXAMPLES

Examples of the present invention and comparative examples will be explained below.

Note that the particle size was measured by using “LA-920” as a laser diffraction/scattering type particle size distribution analyzer manufactured by HORIBA, LTD.

The weight-average molecular weight was measured by gel permeation chromatography.

### Example 1

First, polybutylene succinate (PBS) to be used as the main resin of toner was synthesized as follows.

That is, 0.4 parts by mass of a malic acid and 1 part by mass of germanium dioxide were dissolved in 100 parts by mass of an aqueous solution containing 88-mass % of lactic acid. 5.4 parts by mass of the aqueous solution thus obtained was added to a mixture of 100 parts by mass of succinic acid and 89 parts by mass of 1,4-butanediol. After nitrogen ambient was set in the reaction system, a reaction was performed at 220° C. for 1 hr. Then, while the temperature was raised to 230° C., the pressure was reduced to 70 Pa over 1.5 hrs. After that, polymerization was progressed by further performing the reaction for 2 hrs, thereby obtaining PBS having a softening point of 125° C. The weight-average molecular weight of this PBS was 160,000.

Note that the softening point was measured by using “CFT-500D” manufactured by SHIMADZU CORPORATION. The weight of the sample was 1 g, the temperature increasing rate was 6° C./min, and the load was 20 kg. By using a nozzle having a diameter of 1 mm and a length of 1 mm, a temperature at which the half of the sample flowed was measured as the softening point by the ½ method.

92.5 parts by mass of the synthesized PBS as the main resin, 5 parts by mass of “CLEARON M105” (weight-average molecular weight=1,400) (an aromatic modified hydrogenated terpene resin) manufactured by YASUHARA CHEMICAL CO., LTD. as the low-molecular-weight resin, and 2.5 parts by mass of “CARNAUBA WAX NO, 1 POWDER” imported by S. KATO & CO. were charged in “HENSCHEL MIXER” manufactured by MITSUI MINING CO., LTD. and then mixed together.

The mixture was melt-kneaded by a biaxial kneader, and the obtained kneaded product was coarse-ground by “PELLETIZER” manufactured by NIPPON PLACON CO., LTD. The obtained ground product was frozen and ground under liquid nitrogen by using “LINREX MILL” manufactured by HOSOKAWA MICRON CORPORATION, thereby obtaining a ground product having an average particle diameter D50 (volume) of 9 μm.

After that, film-forming toner A1 was obtained by mixing 100 parts by mass of the ground product and 1 part by mass of hydrophobic silica “R972” manufactured by NIPPON AEROSIL CO., LTD. by using the Henschel mixer.

The TS 12 of the printer 10 explained above was filled with the film-forming toner A1 thus obtained, and printing was performed. In this printing, a solid image shown in FIG. 2 was used as a printing pattern.

### Example 2

Film-forming toner A2 was manufactured by the same procedures as in Example 1 except that “ARKON P100” (weight-average molecular weight=1,600) (alicyclic saturated hydrocarbon) manufactured by ARAKAWA CHEMICAL INDUSTRIES, LTD. was used as the low-molecular-weight resin instead of “CLEARON M105” manufactured by YASUHARA CHEMICAL CO., LTD.

### Example 3

Film-forming toner A3 was manufactured by the same procedures as in Example 1 except that “ARKON M100” (weight-average molecular weight=1,000) (alicyclic saturated hydrocarbon) manufactured by ARAKAWA CHEMICAL INDUSTRIES, LTD. was used as the low-molecular-weight resin instead of “CLEARON M105” manufactured by YASUHARA CHEMICAL CO., LTD.

### Example 4

Film-forming toner A4 was manufactured by the same procedures as in Example 1 except that “FTR2140” (weight-average molecular weight=2,500) (α methylsty-ene-polystyrene) manufactured by MITSUI CHEMICALS INC. was used as the low-molecular-weight resin instead of “CLEARON M105” manufactured by YASUHARA CHEMICAL CO., LTD.

### Example 5

Film-forming toner A5 was manufactured by the same procedures as in Example 1 except that “KE-604” (weight-average molecular weight=350) (acid-modified colorless rosin) manufactured by ARAKAWA CHEMICAL INDUSTRIES, LTD. was used as the low-molecular-weight resin instead of “CLEARON M105” manufactured by YASUHARA CHEMICAL CO., LTD.

### Example 6

Film-forming toner A6 was manufactured by the same procedures as in Example 1 except that “CLEARON P125” (weight-average molecular weight=1,500) (an aromatic modified hydrogenated terpene resin) manufactured by YASUHARA CHEMICAL CO., LTD. was used as the low-molecular-weight resin instead of “CLEARON M105” manufactured by YASUHARA CHEMICAL CO., LTD.

### Example 7

Film-forming toner A7 was manufactured by the same procedures as in Example 1 except that the amount of PBS as the main resin was changed to 57.5 parts by mass, and the amount of “CLEARON M105” as the low-molecular-weight resin was changed to 40 parts by mass.

### Example 8

Film-forming toner A8 was manufactured by the same procedures as in Example 1 except that the average particle diameter D50 (volume) of the ground product before adding external additive was changed to 50 μm.

### Comparative Example 1

Film-forming toner B1 was manufactured by the same procedures as in Example 1 except that the amount of PBS as the main resin was changed to 97.5 parts by mass, and no low-molecular-weight resin was used.

### Comparative Example 2

Film-forming toner B2 was manufactured by the same procedures as in Example 1 except that the amount of PBS as the main resin was changed to 93.5 parts by mass, and the amount of “CLEARON M105” as the low-molecular-weight resin was changed to 4 parts by mass.

### Comparative Example 3

Film-forming toner B3 was manufactured by the same procedures as in Example 1 except that the amount of PBS as the main resin was changed to 56.5 parts by mass, and the amount of “CLEARON M105” as the low-molecular-weight resin was changed to 41 parts by mass.

### Comparative Example 4

Film-forming toner B4 was manufactured following the same procedures as in Example 1 except that the average particle diameter D50 (volume) of the ground product before external filling was changed to 60 μm.

Each example was measured and evaluated by the following methods.

### 1. Grindability of Toner

Each film-forming toner was ground at a feed rate of 5 kg/h for 10 min, and the grindability was evaluated by measuring the average particle diameter D50 (volume).

◯: less than 10 μm

Δ: 10 μm or more and less than 30 μm

x: 30 μm or more

### 2. Charge Amount Measurement

In order to measure the charge amount of the film-forming toner on the developing roll when printing, a solid image was printed on a film adhesive sheet. Then, at the moment the center of the sheet passed the transfer unit, the printer was powered off. The TS was removed in this state, and the charge amount of the toner on the developing roll before the toner was supplied to the photosensitive body was measured.

This charge amount measurement was performed using “MODEL 210HS-3” manufactured by TREK INC. That is, toner on a predetermined area was collected by suction, and the charge amount was calculated from the electric charge and area.

◯: −10 μC/g or more

Δ: 0 μC/g or more, and less than −10 μC/g

X: less than 0 μC/g

### 3. Loading Amount (Mass)

For an image sample of each example, the loading amount (mass) per unit area was measured from a difference between the masses of a sheet before and after printing.

◯: 40 g/m² or more

Δ: 20 g/m² or more, and less than 40 g/m²

X: less than 20 g/m²

### 4. Loading Amount (Visual)

For an image sample of each example, the state of a printed image was visually observed.

◯: Uniform and even.

Δ: Slightly nonuniform and uneven.

X: Nonuniform and uneven.

### 5. Bending Resistance (Visual)

For an image sample of each example, a sheet on which an image was printed was bent, and the presence/absence of breaking and peeling of the image was visually observed.

◯: There was practically no problem.

Δ: A bent portion became clouded.

X: Breaking and/or cracking occurred.

Tables 1 and 2 show the above results.

TABLE 1

| | Composition | | | | | | | |
|---|---|---|---|---|---|---|---|---|
| | | Low-molecular weight resin | | | | | | Carnauba |
| Film- | Main resin | CLEARON | ARKON | ALKON | | | CLEARON | wax No. 1 |
| forming | PBS | M105 | P100 | M100 | FTR2140 | KE604 | P125 | powder |
| toner | (pts. mass) | (pts. mass) | (pts. mass) | (pts. mass) | (pts. mass) | (pts. mass) | (pts. mass) | (pts. mass) |
| A1 | 92.5 | 5 | | | | | | 2.5 |
| A2 | 92.5 | | 5 | | | | | 2.5 |
| A3 | 92.5 | | | 5 | | | | 2.5 |
| A4 | 92.5 | | | | 5 | | | 2.5 |
| A5 | 92.5 | | | | | 5 | | 2.5 |
| A6 | 92.5 | | | | | | 5 | 2.5 |
| A7 | 92.5 | 40 | | | | | | 2.5 |
| A8 | 92.5 | 5 | | | | | | 2.5 |
| B1 | 97.5 | | | | | | | 2.5 |
| B2 | 93.5 | 4 | | | | | | 2.5 |
| B3 | 56.5 | 41 | | | | | | 2.5 |
| B4 | 92.5 | 5 | | | | | | 2.5 |

TABLE 2

| | | Evaluation | | | | |
|---|---|---|---|---|---|---|
| | Toner | Grind- | | | | |
| Film- | particle | ability | Charge | Loading | Loading | Bending |
| forming | diameter | (μm/ | amount | amount | amount | resistance |
| toner | (μm: D50vol) | 10 min) | (μC/g) | (g/m²) | (visual) | (visual) |
| A1 | 9 | ∘ | ∘ | ∘ | ∘ | ∘ |
| A2 | 9 | ∘ | ∘ | ∘ | ∘ | ∘ |
| A3 | 9 | ∘ | ∘ | ∘ | ∘ | ∘ |
| A4 | 9 | ∘ | ∘ | ∘ | ∘ | ∘ |
| A5 | 9 | ∘ | ∘ | ∘ | ∘ | ∘ |
| A6 | 9 | ∘ | ∘ | ∘ | ∘ | ∘ |
| A7 | 9 | ∘ | ∘ | ∘ | ∘ | ∘ |
| A8 | 50 | ∘ | ∘ | ∘ | ∘ | ∘ |
| B1 | 9 | Δ | x | x | x | ∘ |
| B2 | 9 | ∘ | Δ | Δ | Δ | ∘ |
| B3 | 9 | ∘ | ∘ | ∘ | ∘ | Δ |
| B4 | 60 | ∘ | x | Δ | Δ | Δ |

As shown in Table 1, each of the film-forming toners A1 to A8 was film-forming toner in which the weight-average molecular weight of the low-molecular-weight resin used was lower than that of the main resin, the low-molecular-weight resin was contained at a ratio of 5 to 40 mass % with respect to the toner mass, and the average particle diameter D50 (volume) was 9 to 50 μm.

As shown in Table 2, these film-forming toners exhibited good results in all the five items, i.e., the grindability, charge amount, loading amount (g/m²), loading amount (visual), and bending resistance (visual).

On the other hand, the film-forming toner B1 according to Comparative Example 1 in which no low-molecular-weight resin was added had no sufficient performance in the grindability, charge amount, loading amount (g/m²), and loading amount (visual).

Also, comparative examples (the film-forming toners B2 and B3) in which the ratio of the low-molecular-weight resin was not 5 to 40 mass % with respect to the toner mass and a comparative example (the film-forming toner B4) in which the average particle diameter D50 of the toner was larger than 50 μm did not exhibit good results in at least one of the five items.

This application claims the benefit of Japanese Patent Application No. 2013-197006, filed Sep. 24, 2013, which is hereby incorporated by reference herein in its entirety.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### REFERENCE SYMBOL LIST

10 . . . printer
11 . . . printing belt
12 . . . TS
13 . . . developing roll
14 . . . photosensitive body
15 . . . transfer unit
16 . . . fixing unit
17 . . . cassette
18 . . . sheet discharge unit
20 . . . self-adhesive sheet for film
21 . . . solid printing
C . . . sheet path

What is claimed is:

1. A label base composition comprising:
a main resin; and
a low-molecular-weight resin having a weight-average molecular weight lower than that of the main resin,
wherein the low-molecular-weight resin is one or more resins selected from the group consisting of terpene resins, alicyclic hydrocarbon resins, α-methylpolystyrene, modified rosin, novolak resins, modified novolak resins, aliphatic hydrocarbon resins, aromatic hydrocarbon resins, copolymerized resins of these resins, esterified modified rosin, a coumarone resin, C5 and C9 petroleum resins, and derivatives thereof,
a proportion of the low-molecular-weight resin in the label base composition is 5 to 40 mass %, and
the label base composition has an average particle diameter D50 (volume) of 9 to 50 μm.

2. The label base composition according to claim 1, wherein the main resin is positively chargeable, and the low-molecular-weight resin is negatively chargeable.

3. The label base composition according to claim 2, wherein the weight-average molecular weight of the main resin is 10,000 to 250,000, and the weight-average molecular weight of the low-molecular-weight resin is equal to or more than 200 and less than 10,000.

4. The label base composition according to claim 1, wherein the weight-average molecular weight of the main resin is 10,000 to 250,000, and the weight-average molecular weight of the low-molecular-weight resin is equal to or more than 200 and less than 10,000.
